(19) United States
(12) Patent Application Publication
(10) Pub. No.: US 2018/0269662 A1
(43) Pub. Date: Sep. 20, 2018

(54) Output Power Distribution Module and Power Distribution Cabinet

(71) Applicant: Huawei Technologies Co., Ltd., Shenzhen (CN)

(72) Inventors: Qingfei Song, Xi'an (CN); Yong Li, Shenzhen (CN)

(21) Appl. No.: 15/985,103

(22) Filed: May 21, 2018

Related U.S. Application Data
(63) Continuation of application No. PCT/CN2016/101966, filed on Oct. 13, 2016.

(30) Foreign Application Priority Data
Nov. 19, 2015 (CN) 201510812417.2

(51) Int. Cl. H02B 1/20; H02B 1/04

(52) U.S. Cl. CPC H02B 1/20; H02B 1/04

(57) ABSTRACT

An output power distribution module and a power distribution cabinet belong to the field of power electronics technologies. Input copper bars providing a main shunt function for the output power distribution module are integrated to the output power distribution module, thereby reducing a quantity of used copper bars, reducing costs, simplifying assembling steps, and improving assembling efficiency.

### CROSS-REFERENCE TO RELATED APPLICATIONS

This application is a continuation of International Patent Application No. PCT/CN2016/101966 filed on Oct. 13, 2016, which claims priority to Chinese Patent Application No. 201510812417.2 filed on Nov. 19, 2015. The disclosures of the aforementioned applications are hereby incorporated by reference in their entireties.

### TECHNICAL FIELD

The present disclosure relates to the field of power electronics technologies, and in particular, to an output power distribution module and a power distribution cabinet.

### BACKGROUND

With continuous development of power electronics technologies, there are more types of power distribution devices, and functions of the power distribution devices are increasingly improved.

At present, various power distribution components inside a power distribution device are all installed in a mechanical part of a cabinet body. The cabinet body and the power distribution components are connected together using cables, such as a vertical main busbar that provides a main shunt function for an output power distribution module, and a module interconnection busbar. A branch busbar is disposed in the output power distribution module and is connected to the main busbar by means of plug-in connection or the like, to implement internal connection of the entire cabinet.

In a process of implementing the present disclosure, the inventor finds that the other approaches have at least the following problems.

A copper bar design in an existing power distribution cabinet causes a complex internal structure of the power distribution cabinet, time-consuming assembling, and low efficiency. In addition, a large quantity of copper bars are used, and costs are high.

### SUMMARY

To resolve foregoing problems, embodiments of the present disclosure provide an output power distribution module and a power distribution cabinet.

According to an aspect, an output power distribution module is provided. The output power distribution module includes a power distribution control module and an intermediate framework, where a power board, a monitor board, an output circuit breaker, and a customer wiring terminal are integrated inside the power distribution control module, input copper bars are integrated on the intermediate framework, the input copper bars are connected to the power board, the monitor board, and the output circuit breaker using a cable, the input copper bars are configured to bear a current inside a power distribution cabinet, and transmit an output value of the current to a next output power distribution module, and the input copper bars are further configured to distribute, using the cable, an input current to the power board, the monitor board, and the output circuit breaker, and the output circuit breaker outputs an input current to the customer wiring terminal. The input copper bars are integrated to the output power distribution module, thereby reducing a quantity of used copper bars inside the power distribution cabinet and reducing costs.

In a first possible implementation of the first aspect of the present disclosure, output ends of the input copper bars are connected, by means of bonding, to input ends of input copper bars that are integrated to the next output power distribution module. Input copper bars of two adjacent output power distribution modules are connected by means of bonding, thereby simplifying an assembling process and improving assembling efficiency.

In a second possible implementation of the first aspect of the present disclosure, the bonding is implemented by plug-in connection of terminals. Bonding of input copper bars between modules is implemented by means of plug-in connection of terminals, thereby reducing time consumption of assembling and improving assembling efficiency.

In a third possible implementation of the first aspect of the present disclosure, the bonding is implemented by fastening a screw. Bonding of input copper bars between modules is implemented by fastening a screw, thereby reducing assembling complexity on a basis of ensuring installation stability.

In the third possible implementation of the first aspect of the present disclosure, input ends of the input copper bars are in a bending structure, and output ends of the input copper bars are in a vertical structure. The input ends of the input copper bars are designed as the bending structure. Therefore, on a basis of ensuring that space occupied by the input copper bars does not increase, an output end of a previous module can be connected to the output power distribution module by means of bonding.

According to another aspect, a power distribution cabinet is provided. The power distribution cabinet includes a cabinet body, an input module, and at least one output power distribution module, where input copper bars are integrated inside each of the at least one output power distribution module, the at least one output power distribution module forms a series path by means of bonding between input copper bars such that a current that is input by the input module is connected from the first output power distribution module in the at least one output power distribution module to the last output power distribution module in the at least one output power distribution module, and the input copper bars integrated inside each output power distribution module are further configured to supply power to a customer wiring terminal of each output power distribution module.

The technical solutions provided in the embodiments of the present disclosure bring the following beneficial effect.

Input copper bars are integrated to an output power distribution module, thereby reducing a quantity of used copper bars, reducing costs, simplifying assembling steps, and improving assembling efficiency.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1A is a view of an output power distribution module according to an embodiment of the present disclosure;

FIG. 1B is another view of an output power distribution module according to an embodiment of the present disclosure;

FIG. 2 is a schematic structural diagram of a power distribution cabinet according to an embodiment of the present disclosure; and

FIG. 3 is a schematic diagram of bonding of input copper bars in a power distribution cabinet according to an embodiment of the present disclosure.

### DESCRIPTION OF EMBODIMENTS

To make the objectives, technical solutions, and advantages of the present disclosure clearer, the following further describes the embodiments of the present disclosure in detail with reference to the accompanying drawings.

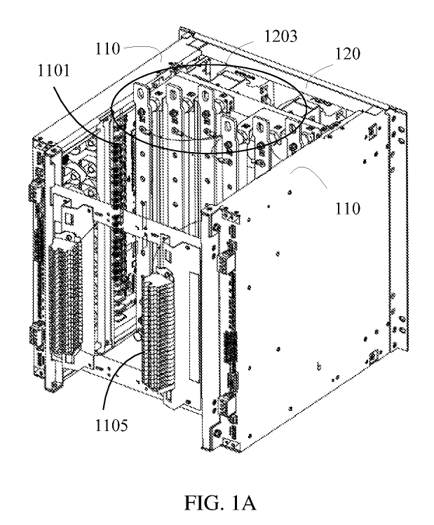

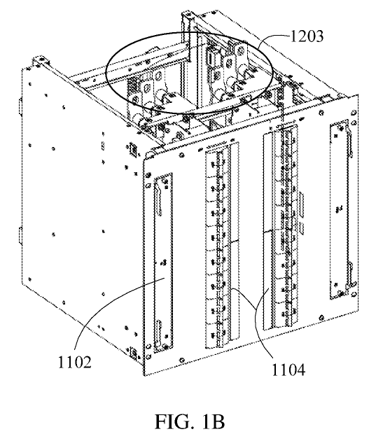

FIG. 1A is a view of an output power distribution module according to an embodiment of the present disclosure. To better describe an entire structure of the output power distribution module, an embodiment of the present disclosure further provides another view of the output power distribution module, as shown in FIG. 1B. With reference to FIG. 1A and FIG. 1B, it can be known that the output power distribution module includes a power distribution control module 110 and an intermediate framework 120.

A power board 1101, a monitor board 1102, an output circuit breaker 1104, and a customer wiring terminal 1105 are integrated inside the power distribution control module 110. Input copper bars 1203 are integrated on the intermediate framework 120. The customer wiring terminal 1105 serves as a power supply port for a user to use. The output circuit breaker 1104 is configured to implement electrical isolation. The output circuit breaker 1104 and the customer wiring terminal 1105 are connected using a cable. The input copper bars 1203 are connected to the power board 1101, the monitor board 1102, and the output circuit breaker 1104 using a cable. The input copper bars 1203 are configured to bear a current inside a power distribution cabinet, and transmit an output value of the current to a next output power distribution module. The input copper bars 1203 are further configured to distribute, using the cable, an input current to the power board 1101, the monitor board 1102, and the output circuit breaker 1104, and the output circuit breaker 1104 outputs an input current to the customer wiring terminal 1105.

The power distribution control module 110 may be divided into a left-side module and a right-side module. The left-side module and the right-side module are in a left-right symmetric structure. A power board, a monitor board, an output circuit breaker, and a customer wiring terminal are integrated in each of the left-side module and the right-side module.

It should be noted that, according to the output power distribution module provided in this disclosed embodiment, a copper bar that provides a main shunt function for the output power distribution module is integrated inside the output power distribution module such that the output power distribution module has a current conduction function of the output power distribution module, and when the output power distribution module is assembled in a power distribution cabinet, can conduct, using input copper bars 1203, a current in an input module in the power distribution cabinet to an output power distribution module connected to the input module. An output end of the output power distribution module may be further connected to an output power distribution module that has a same structure as the output power distribution module. After input copper bars in each input power distribution module are connected, a current conduction function among all modules in the power distribution cabinet can be implemented.

In a structure of the foregoing output power distribution module, the input copper bars 1203 and the output power distribution module are integrated to form an entirety, thereby reducing a quantity of used copper bars and simplifying assembling steps.

In a possible implementation of this embodiment of the present disclosure, input ends of the input copper bars 1203 are in a bending structure, and output ends of the input copper bars 1203 are in a vertical structure. It can be known from FIG. 1A that the input ends of the input copper bars 1203 are in the bending structure, and the output ends are in the vertical structure such that the output power distribution module can implement automatic bonding with another output power distribution module. As shown in FIG. 1A, flat cables included in each group of input copper bars in the input copper bars 1203 may be arranged in a step shape, or may be arranged on a same horizontal line. This embodiment of the present disclosure does not impose a limitation herein.

The output ends of the input copper bars 1203 are connected, by means of bonding, to input ends of input copper bars 1203 that are integrated to the next output power distribution module. An implementation method of the bonding may be implemented by plug-in connection of terminals, or may be implemented by fastening a screw. Certainly, the bonding may also be implemented using another method. This embodiment of the present disclosure does not impose a limitation herein.

It should be noted that a guide rail may be further installed at the bottom or on a side of the output power distribution module provided in this embodiment of the present disclosure such that the output power distribution module can be put into a power distribution cabinet or removed from a power distribution cabinet. This embodiment of the present disclosure does not impose a limitation on a specific structure of the guide rail or a location of the guide rail in the output power distribution module.

In another embodiment of the present disclosure, an assembling process of the output power distribution module provided in this embodiment of the present disclosure may be installing input copper bars 1203 on an intermediate framework 120, and separately connecting, using a cable, input ends and output ends of the input copper bars 1203 to the intermediate framework 120, installing power boards in corresponding locations of a left-side module and a right-side module of a power distribution control module 110, and connecting, using a cable, the power boards 1101 to miniature circuit breakers, and installing the left-side module and the right-side module of the power distribution control module 110 on the intermediate framework 120, where the miniature circuit breakers are configured to control connectivity of a current of a customer wiring terminal in the output power distribution module.

In another embodiment of the present disclosure, a manner of connecting the left-side module and the right-side module of the power distribution control module 110 to the intermediate framework 120 may be a foolproof mounting manner. In this connection manner, a mistake is avoided when the intermediate framework 120 is connected to the left-side module and the right-side module, thereby ensuring installation accuracy.

For the foregoing installation manner, provided that an installation result is not affected, some installation steps may also be adaptively adjusted. This embodiment of the present disclosure does not impose a limitation herein.

In addition to the foregoing installation manner, another installation manner may also be used to install the output power distribution module provided in this embodiment of the present disclosure. This embodiment of the present disclosure does not impose a limitation herein.

According to the output power distribution module provided in this embodiment of the present disclosure, input copper bars are integrated to the output power distribution module, thereby reducing a quantity of used copper bars, reducing costs, simplifying assembling steps, and improving assembling efficiency. In addition, copper bars between output power distribution modules and between an output power distribution module and an input module are connected by means of bonding, thereby implementing current conduction between the modules.

It should be noted that the output power distribution module provided in this embodiment of the present disclosure may be applied to a low-voltage power distribution cabinet, or may be applied to a high-voltage power distribution cabinet.

All of the foregoing optional technical solutions may form, using any combination, optional embodiments disclosed by the present disclosure. Details are not described herein.

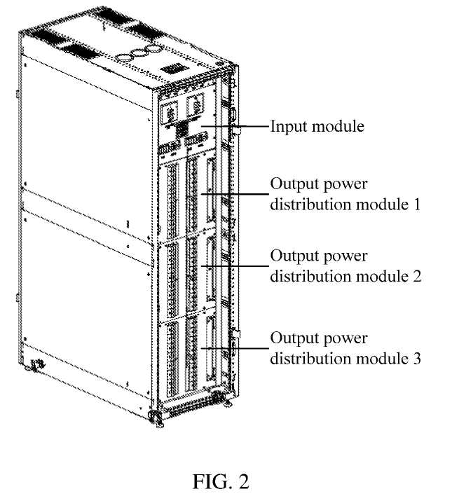

FIG. 2 is a schematic structural diagram of a power distribution cabinet according to an embodiment of the present disclosure. The power distribution cabinet includes a cabinet body, an input module, and at least one output power distribution module (designated as output power distribution module 1, output power distribution module 2, and output power distribution module 3). Input copper bars are integrated inside each of the at least one output power distribution module. The at least one output power distribution module forms a series path by means of bonding between input copper bars such that a current that is input by the input module is connected from the first output power distribution module in the at least one output power distribution module to the last output power distribution module in the at least one output power distribution module. The input copper bars integrated inside each output power distribution module are further configured to supply power to a customer wiring terminal of each output power distribution module.

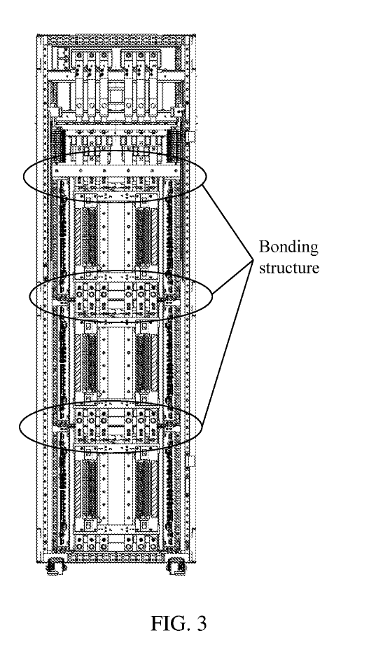

Using FIG. 2 as an example, FIG. 2 shows a power distribution cabinet assembled with three output power distribution modules. An input module and an output power distribution module 1 in the power distribution cabinet are vertically connected by means of bonding of copper bars. All output power distribution power modules are vertically connected by means of bonding of input copper bars, thereby forming a series path. A current in the input module sequentially flows, from top to bottom, into the three output power distribution modules by means of conduction by the input copper bars integrated inside the multiple output power distribution modules. FIG. 3 shows a bonding structure formed by sequential bonding of the input copper bars in the modules in the power distribution cabinet.

It should be noted that a method for installing the output power distribution modules in the power distribution cabinet may be assembling the output power distribution modules in a plug-in manner using a guide rail or a slot on the power distribution cabinet. If an output power distribution module in the power distribution cabinet becomes faulty, the output power distribution module may be independently removed, and the output power distribution module is replaced or repaired, without a need of disassembling the entire power distribution cabinet, thereby improving repair efficiency. Certainly, the output power distribution modules may also be installed in another manner in which the output power distribution modules can be easily inserted and removed. This embodiment of the present disclosure does not impose a limitation herein.

It should be noted that, according to the output power distribution module and the power distribution cabinet provided in the foregoing embodiments, division of the foregoing functional modules is used as an example for description. In an actual application, the foregoing functions may be completed by different functional modules as required, that is, internal structures of the output power distribution module and the power distribution cabinet are divided into different functional modules to implement all or some of the functions described above. In addition, the output power distribution module and the power distribution cabinet provided in the foregoing embodiments belong to a same idea. For details about specific implementation processes of the output power distribution module and the power distribution cabinet, reference may be made to the method embodiments. Details are not described herein.

1. An output power distribution apparatus, comprising:
an intermediate framework;
a power distribution control device coupled to the intermediate framework, a power board, a monitor board, an output circuit breaker, and a customer wiring terminal being integrated inside the power distribution control device; and
input copper bars being integrated on the intermediate framework and coupled to the power board, the monitor board, and the output circuit breaker using a cable, the input copper bars being configured to:
bear a current inside a power distribution cabinet;
transmit an output value of the current to a next output power distribution apparatus; and
distribute, using the cable, an input current to the power board, the monitor board, and the output circuit breaker, the output circuit breaker being configured to output the input current to the customer wiring terminal.

2. The output power distribution apparatus of claim 1, wherein output ends of the input copper bars are coupled, by bonding, to input ends of the input copper bars integrated to the next output power distribution apparatus.

3. The output power distribution apparatus of claim 2, wherein the bonding is implemented by plug-in coupling of terminals.

4. The output power distribution apparatus of claim 2, wherein the bonding is implemented by fastening a screw.

5. The output power distribution apparatus of claim 1, wherein input ends of the input copper bars are in a bending structure, and output ends of the input copper bars being in a vertical structure.

6. A power distribution cabinet, comprising:
a cabinet body;
an input circuit coupled to the cabinet body; and
at least one output power distribution apparatus coupled to the cabinet body and the input circuit, input copper bars being integrated inside each of the at least one output power distribution apparatus, the at least one output power distribution apparatus forming a series path by bonding among the input copper bars such that a current from the input circuit is coupled from a first output power distribution apparatus in the at least one output power distribution apparatus to a last output power distribution apparatus in the at least one output power distribution apparatus, and the input copper bars integrated inside each output power distribution apparatus being configured to supply power to a customer wiring terminal of each output power distribution apparatus.
